(19) United States
(12) Patent Application Publication
(10) Pub. No.: US 2020/0293865 A1
(43) Pub. Date: Sep. 17, 2020

(54) USING IDENTITY LAYER IN A CELLULAR NEURAL NETWORK ARCHITECTURE

(71) Applicant: Gyrfalcon Technology Inc., Milpitas, CA (US)

(72) Inventors: Bowei Liu, Fremont, CA (US); Yinbo Shi, Santa Clara, CA (US); Yequn Zhang, San Jose, CA (US); Xiaochun Li, San Ramon, CA (US)

(73) Assignee: Gyrfalcon Technology Inc., Milpitas, CA (US)

(21) Appl. No.: 16/353,810

(22) Filed: Mar. 14, 2019

(51) Int. Cl. G06N 3/063; G06F 17/15; G06N 3/08

(52) U.S. Cl. CPC G06N 3/063; G06F 11/3664; G06N 3/08; G06F 17/15

(57) ABSTRACT

A cellular neural network architecture may include a processor and embedded cellular, neural network (CeNN) executable in an artificial intelligence (AI) integrated circuit and configured to perform certain AI functions. The CeNN may include multiple convolution layers, each having multiple binary weights. In some examples, a method may configure a given layer of the CeNN and one or more additional layers of the CeNN to retrieve the output of the given layer for debugging or training the CeNN. In configuring the one or more additional layers, the method may use an identity layer.

### FIELD

This patent document relates generally to, systems and methods for providing artificial intelligence solutions. Examples of obtaining output of a given convolution layer in a cellular neural network architecture are provided.

### BACKGROUND

Artificial intelligence solutions are emerging with the advancement of computing platforms and integrated circuit solutions. For example, an intelligence (AI) integrated circuit (IC) may include a processor capable of performing AI tasks in embedded hardware. Hardware accelerators have recently emerged and can quickly and efficiently perform AI functions, such as voice or image recognitions, at the cost of precision in the input image tensor as well as the weights of the AI models. For example, in a hardware-based solution, such as a physical AI chip having an embedded cellular neural network (CeNN), the number of channels may be limited, e.g., to 3, 8, 16, or 128 channels. The bit-width of weights and/or parameters of an AI chip may also be limited. For example, the weights of a convolution layer in the CeNN may be constrained to 1-bit, such as a signed 1-bit having a value of {+1, −1}, with a configurable shared bit multiplier or bit shifter such that the average magnitude of the outputs is not too large.

The constraints of the hardware solutions make it difficult to implement certain AI functions or develop certain AI models. For example, in software, and/or hardware development of an AI solution, such as obtaining or training an optimal AI model that is executable in a CeNN of an AI chip, it is often desirable to test certain individual components of the solution, such as a given convolution layer of the CeNN. An identity convolution can be applied to cause a large portion of the neural network to pass through the intermediate results, which facilitates access to the output of intermediate convolution layers. An identity convolution may be useful in certain applications. When the identity convolution is applied to a neural network, the output of the convolution is the same as the input. Identity convolution is recently used in ResNet network architecture, such as presented by He et. al. in “Deep residual learning for image recognition,” CoRR, abs/1512.03385, 2015, where identity convolution was shown to improve the training of a neural network. However, in a hardware-constrained cellular network solution, identity convolution may not be readily applied. For example, in an AI chip in which the w eights of the AI model having two values {+1, −1}, an identity convolution that requires a value of 0 or 1 cannot be readily represented in the hardware architecture.

This document is directed to systems and methods for addressing the above issues and/or other issues.

### BRIEF DESCRIPTION OF THE DRAWINGS

The present solution will be described with reference to the following figures, in which like numerals represent like items throughout the figures.

FIG. 1A illustrates an example AI chip in accordance with various examples described herein.

FIG. 1B illustrates an example AI model that may be embedded in a CeNN in an AI chip in accordance w with various examples described herein.

FIGS. 2A-2C illustrate various configurations of a CeNN in an AI chip in accordance with various examples described herein.

FIGS. 3A-3B illustrate diagrams of example processes of retrieving output of a given convolution layer in an AI chip in accordance with various examples described herein.

FIGS. 4A-4C illustrate various configurations of a CeNN in an AI chip in accordance with various examples described herein.

FIGS. 5A and 5B illustrate diagrams of example processes of configuring a CeNN to generate residual connection and training a CNN with residual connection in accordance with various examples described herein.

FIG. 6 illustrates various embodiments of one or more electronic devices for implementing the various methods and processes described herein.

### DETAILED DESCRIPTION

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

Each of the terms “artificial intelligence logic circuit” and “AI logic circuit” refers to a logic circuit that is configured to execute certain AI functions such as a neural network in AI or machine learning tasks. An AI logic circuit can be a processor. An AI logic circuit can also be a logic circuit that is controlled by an external processor and executes certain AI functions.

Each of the terms “integrated circuit,” “semiconductor chip,” “chip,” and “semiconductor device” refers to an integrated circuit (IC) that contains electronic circuits on semiconductor materials, such as silicon, for performing certain functions. For example, an integrated circuit can be a microprocessor, a memory, a programmable array logic (PAL) device, an application-specific integrated circuit (ASIC), or others. An integrated circuit that contains an AI logic circuit is referred to as an AI integrated circuit.

The term “AI chip” refers to a hardware- or software-based device that is capable of performing functions of an AI logic circuit. An AI chip can be a physical IC. For example, a physical AI chip, may include an embedded CeNN, which may contain weights and/or parameters of a CNN. The AI chip may also be a virtual chip, i.e., software-based. For example, a virtual AI chip may include one or more processor simulators to implement functions of a desired AI logic circuit of a physical AI chip.

The term of “AI model” refers to data that include one or more weights that, when loaded inside an AI chip, are used for executing the AI chip. For example, an AI model for a given CNN may include the weights, bias, and other parameters for one or more convolutional layers of the CNN. Here, the weights and parameters of an AI model are interchangeable.

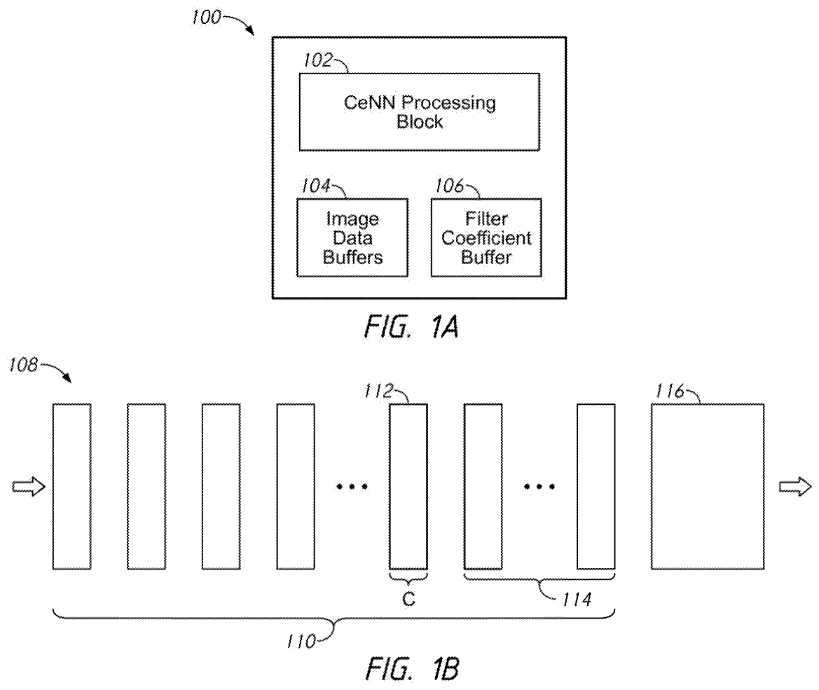

FIG. 1A illustrates an example AI chip in accordance with various examples described herein. In some examples, an AI chip 100 may include a CeNN processing block 102. The CeNN processing block 102 may include an AI model configured to perform certain AI tasks. In some examples, an AI model may include a forward propagation neural network, in which information may flow from the input layer to one or more hidden layers of the network to the output layer. For example, an AI model may include a CNN that is trained to perform voice or image recognition tasks.

FIG. 1B illustrates an example CeNN architecture in accordance with some examples described herein. An AI model 108 may be loaded in a CeNN of an AI chip. The AI model 108 may include a CNN, which may include multiple convolutional layers 110. The AI model 108 may also include one or more fully connected layers 114. Each of the layers may include multiple parameters, such as weights and/or other parameters. In such case, an AI model may include parameters of the CNN model. In some examples, a CNN model may include weights, such as a mask and a scalar for a given layer of the CNN model. In some examples, a kernel in a CNN layer may be represented by a mask that has multiple values in lower precision multiplied by a scalar in higher precision. In some examples, a CNN model may include other parameters. For example, an output channel of a CNN layer may include one or more bias values that, when added to the output of the output channel, adjust the output values to a desired range.

In a non-limiting example, in a CNN model, a computation in a given layer in the CNN may be expressed by y=W×b, where x is input data, y is output data in the given layer, W is a kernel, and b is a bias. Operation “*” is a convolution. Kernel W may include binary values. For example, a kernel may include nine, cells in a 3×3 mask, where each cell may have a binary value, such as “1” or “−1.” In such case, a kernel may be expressed by multiple binary values in the 3×3 mask multiplied by a scalar. The scalar may include a value having a bit width, such as 8-32-bit, for example, 12-bit or 16-bit. Other bit length may also be possible. By multiplying each binary value in the 3×3 mask with the scalar, a kernel may contain values of higher bit-length. Alternatively, and/or additionally, a kernel may contain data with n-value, such as 7-value. The bias b may contain a value having multiple bits, such as 8, 12, 16, 32 bits. Other bit length may also be possible.

In the case of a physical AI chip, the AI chip may include an embedded CeNN that has memory containing the multiple parameters in the CNN. In some scenarios, the memory in a physical AI chip may be a one-time-programmable (OTP) memory that allows a user to load a CNN model into the physical AI chip once. Alternatively, a physical AI chip may have a random access memory (RAM) or other types of memory that allows a user to update and load a CNN model into the physical AI chip multiple times.

In the case of a virtual AI chip, the AI chip may include a data structure that simulates the CeNN in a physical AI chip. A virtual AI chip can be particularly advantageous in training a CNN, in which multiple tests need to be run over various CNNs in order to determine a model that produces the best performance (e.g., highest recognition rate or lowest error rate). In a test run, the parameters in the CNN can vary and be loaded into the virtual AI chip without the cost associated with a physical AI chip. Only after the CNN model is determined will the parameters of the CNN model be loaded into a physical AI chip for real-time applications. Alternatively, a physical AI chip may be used in training a CNN. Training a CNN model may require significant amounts of computing power, even with a physical AI chip, because a CNN model may include millions of weights. For example, a modern physical AI chip may be capable of storing a few megabytes of weights inside the chip.

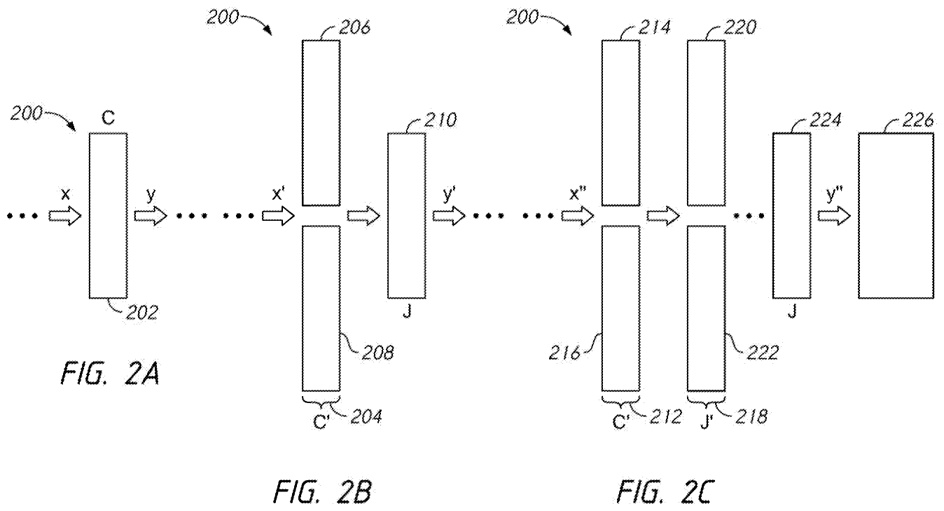

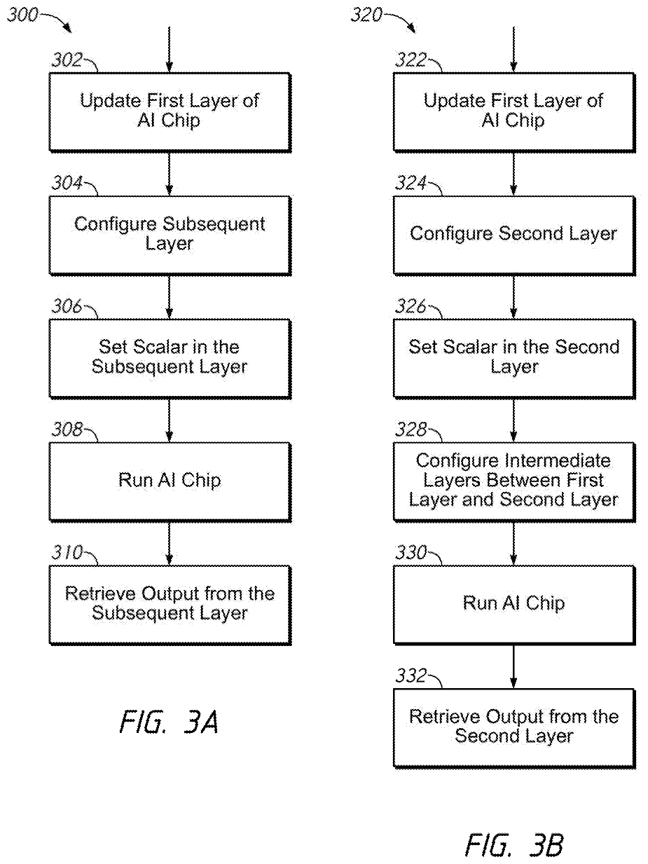

In some examples, an AI chip may be configured to allow the hardware to only allow for extracting CNN outputs right before the fully connected layers. In some examples, an AI chip may be configured to allow modification to the one or more weights and/or parameters of the AI model. In some examples, an AI chip may be configured to reverse any modifications to the network loaded on the hardware. For example, a copy of the original network weights and/or parameters before modification thereof may be stored in a memory and reloaded to the AI chip after such modification. The AI chip 100 may be configured to make the output of a given layer, such as an intermediate layer C at 112, accessible to an external processing device. In obtaining the output of the intermediate layer C, the weights and/or parameters of one or more layers between layer C and fully connected layer(s) 116, such as layers 114, may be modified such that the output of layer C is carried out to the fully connected layer and to the output of the AI chip. In other words, one or more layers of the AI chip may be configured such that the final output of the convolution layers 110 will be equivalent to the output of the layer C at 112, effectively “bypassing” the one or more layers between layer C and fully connected layer(s), such as 114. This configuration may be useful for debugging an AI model in a hardware AI chip, where the output of a given convolution layer may be made accessible at the output of the AI chip for examination. For example, a processing device may be coupled to the AI chip to receive the output of the given convolution layer for debugging. After debugging, the weights of the original AI model or the new weights may be load ed onto the AI chip for real-time execution of AI tasks. Details of the configuration are further described with reference to FIGS. 2-3.

In some scenarios, the AI chip 100 may also include image data buffer 104 and filter coefficient butler 106. The image data buffer 104 may contain an input image obtained from a sensor or an output image from a convolution layer in the CNN. In some scenarios, the sensor image in the image data butler 104 may be provided to the CeNN processing block 102 to perform an AI task. In some scenarios, voice data captured from an audio sensor may be converted to an image, such as a spectrogram, to be stored in the image data buffer 104 and provided to the CeNN processing block 102 to perform a voice recognition task. The filter coefficient buffer 106 may contain one or more weights and/or parameters of the CNN in the AI chip. In a hardware solution, the filter coefficient buffer may be coupled into the CeNN processing block 102. For example, the filter coefficient buffer may contain the weights (e.g., kernels and scalars), bias, or other parameters of the CNN in the CeNN processing, block.

FIGS. 2A-2C illustrate various configurations of a CeNN in developing an AI model or executing certain AI functions in an AI chip in accordance with various examples described herein. Convolution layers as used in deep convolution neural nets have certain meta-parameters and certain weight parameters, which, when applied to input image “tensors”, e.g., input image data of a fixed width, height, and number of “color” channels, will transform them into output image tensors, of a fixed but possibly different width, height, or number of channels. FIG. 2A illustrates an intermediate layer C (202) of a CeNN 200. FIG. 2B illustrates an updated intermediate layer C, such as C′ (204), and an identity layer J (210) immediately following layer C″ (204), where the output of layer 210 is equivalent to the output of layer 202 in FIG. 2A. In other words, J(C′)(x))=C(x), where function ( ) represents the operation of a convolution layer, such as a convolution operation. In some examples, FIG. 2B illustrates updates of multiple layers following the intermediate layer C′, such as J′ (218) and J (224), where J(J′(C′(x)))=C(x). Similar updates may be implemented in one or more layers in the CeNN so that the output of the intermediate layer C may be carried all the way to the fully connected layer of the CeNN and to the output of the AI chip.

In some examples, a CeNN in an AI chip may be configured to operate in two modes. In a normal execution mode, the CeNN may be configured to perform an AI task. For example, layer C (202) in FIG. 2A may be an intermediate layer in a CeNN which, when loaded in the AI chip, may perform an AI task, such as an audio or image recognition task. In some examples, the CeNN in the AI chip may also operate in a debugging mode, under which output, of a given convolution layer of the CeNN may be directly produced from the AI chip. For example, as shown in FIG. 2B, layer C (202) may be updated into layer C′ (204), and subsequent layer (210) may be configured to be an identity layer. Altogether, the updated layer C′and J enable the CeNN to operate in a debugging mode. In the debugging, mode, the output of layer C may be directly output from the AI chip.

In some examples, with reference to FIG. 2A, the input of layer C (202) x may be an image tensor w×h×n₀ (width, height, number of channels), and the output of the layer C (202) y may be an image tensor w′×h′×n₁, where the relationship between w×h×n₀ and w′33 h′×n₁ may be determined by the meta-parameters of layer C, such as stride, padding settings, and/or kernel size. In some examples, the stride and padding settings may be constant. The kernel size may control the size of receptive fields of the convolution. In some examples, the kernel size may have equal width and height, for example, k=k_{w}=kₕ. Then it follows that the weights of the convolutional layer may be arranged in a 4-dimensional (4-D)) matrix (tensor), which is denoted by C.

C=Cᵢⱼₗₘ, 1≤i≤n₀, 1≤j≤nⱼ, 1≤l≤k_{w}, 1≤m≤kₕ.

In this 4-D representation, there is a distinct floating-point weight at every combination of the 4 settings: input channel dimension, output channel dimension, kernel x-coordinate, and kernel y-coordinate. The weight tensor of a convolutional layer may be expressed as

C_{if} ∈R^{k}^{_{w}}^{×k}^{ₕ} and (Cᵢⱼ)ₗₘ=Cᵢⱼₗₘ

For each pair i=input channel dimension index and j=output channel dimension index, Cᵢⱼ is a single convolutional filter of size k_{w}×kₕ.

With reference to FIG. 2B, the layer C maybe modified as C′ 204, which has two parts 206, 208. In some examples, the layer C′ may include twice the output channels (with the dimension of w′×h′×2n₁) while the stride, paddines, and/or kernel size are the same as those in layer C. In this case, the weights of the layer C′ may be represented by:

$${C}_{ij}^{′} = \{ \begin{matrix}{C}_{ij} , & 1 \leq j \leq {n}_{1} , \\ {C}_{i , j} - {n}_{1} , & {n}_{1} + 1 \leq j \leq 2 {n}_{1}\end{matrix} ,$$

As shown, the weights of layer C′ may be copied and duplicated from the weights of layer C by the number of output channels, where the first part 206 is copied from the weighs of layer C, and the second part 208 is duplicated from the weights of layer C, to form an additional number of output channels. The number of additiot al. output channels may be the same as the number of output channels of layer C. This effectively doubles the number of output channels in layer C′.

In a non-limiting example, when the number of input channels of layer C (e.g., 202 in FIG. 2A) n₀=3 and the number of output channels n₁=4, and if the weights of layer C are given by:

$$C = ( \begin{matrix}{C}_{11} & {C}_{12} & {C}_{13} \\ {C}_{21} & {C}_{22} & {C}_{23} \\ {C}_{31} & {C}_{32} & {C}_{33} \\ {C}_{41} & {C}_{42} & {C}_{43}\end{matrix} )$$

then the layer 210 may have the weights arranged as:

$${C}^{′} = ( \begin{matrix}C \\ C\end{matrix} ) = ( \begin{matrix}\begin{matrix}{C}_{11} & {C}_{12} & {C}_{13} \\ {C}_{21} & {C}_{22} & {C}_{23} \\ {C}_{31} & {C}_{32} & {C}_{33} \\ {C}_{41} & {C}_{42} & {C}_{43} \\ & & \end{matrix} \\ \begin{matrix}{C}_{11} & {C}_{12} & {C}_{13} \\ {C}_{21} & {C}_{22} & {C}_{23} \\ {C}_{31} & {C}_{32} & {C}_{33} \\ {C}_{41} & {C}_{42} & {C}_{43}\end{matrix}\end{matrix} ) ,$$

As shown, the weights as layer C′ are duplicated once from the weights in layer C to form the weights for 8 output channels.

In some examples, a new layer, e.g., an identity layer J (210), may be added to the configuration. In some examples, the succeeding layer of the updated layer C′ may be configured as an identity layer J. With that, the output of the layer J, such as y′ may become the same as the output of the layer such as C, such as J(C′(x))=C(x). The construction of the identity layer is now described in detail.

In some examples, a new layer J(210) may be configured to be an identity layer which may be used as a non-operation layer such that the output of the new layer may be the same as the output of its preceding layer. In a non-limiting example, the layer may have the stride of 1, and the same padding as the preceding layer. When the kernel size is an odd number, the weights of the layer J 210 may be configured to have the number of input channels as 2n₁and the number of output channels as n₁. In other words, the layer 210 may be configured to transform image tensor from w′×h′×2n₁ to w′×h′x₁′:

$${J}_{ij} = \{ \begin{matrix}{N}_{1} , & i = j \\ {P}_{1} , & i = j + {n}_{1} \\ {N}_{0} , & i \neq j , 1 \leq i \leq {n}_{1} , \\ {P}_{0} , & i \neq j , {n}_{1} + 1 \leq i \leq 2 {n}_{1}\end{matrix} ,$$

where N₁, P₁ may be matrices having sizes k_{w}×kₕ, and binary value of ±1 such that N₁+P₁=21, and N₀, P₀ may be matrices having sizes k_{w}×kₕ, and binary value of ±1 such that N₀+P₀=0.

In a non-limiting example in which the kernel size is 3×3, the matrices may be configured to have the values:

$${N}_{1} = ( \begin{matrix}- 1 & - 1 & - 1 \\ - 1 & 1 & - 1 \\ - 1 & - 1 & - 1\end{matrix} ) , {P}_{1} = ( \begin{matrix}1 & 1 & 1 \\ 1 & 1 & 1 \\ 1 & 1 & 1\end{matrix} ) , {N}_{0} = ( \begin{matrix}- 1 & - 1 & - 1 \\ - 1 & - 1 & - 1 \\ - 1 & - 1 & - 1\end{matrix} ) , \\ {P}_{0} = {P}_{1} .$$

In another non-limiting example in which the kernel size is 5×5, the matrices may be configured to have the values:

$${N}_{1} = ( \begin{matrix}- 1 & - 1 & - 1 & - 1 & - 1 \\ - 1 & - 1 & - 1 & - 1 & - 1 \\ - 1 & - 1 & 1 & - 1 & - 1 \\ - 1 & - 1 & - 1 & - 1 & - 1 \\ - 1 & - 1 & - 1 & - 1 & - 1\end{matrix} ) , {P}_{1} = ( \begin{matrix}1 & 1 & 1 & 1 & 1 \\ 1 & 1 & 1 & 1 & 1 \\ 1 & 1 & 1 & 1 & 1 \\ 1 & 1 & 1 & 1 & 1 \\ 1 & 1 & 1 & 1 & 1\end{matrix} ) , \\ {N}_{0} = ( \begin{matrix}- 1 & - 1 & - 1 & - 1 & - 1 \\ - 1 & - 1 & - 1 & - 1 & - 1 \\ - 1 & - 1 & - 1 & - 1 & - 1 \\ - 1 & - 1 & - 1 & - 1 & - 1 \\ - 1 & - 1 & - 1 & - 1 & - 1\end{matrix} ) , {P}_{0} = {P}_{1} .$$

These matrices may form any number of channels in the layer C′. In the above example, when n=4, the weights in the layer J(210) may be configured to have the values:

$$J = ( \begin{matrix}{N}_{1} & {N}_{0} & {N}_{0} & {N}_{0} & & {P}_{1} & {P}_{0} & {P}_{0} & {P}_{0} \\ {N}_{0} & {N}_{1} & {N}_{0} & {N}_{0} & & {P}_{0} & {P}_{1} & {P}_{0} & {P}_{0} \\ {N}_{0} & {N}_{0} & {N}_{1} & {N}_{0} & & {P}_{0} & {P}_{0} & {P}_{1} & {P}_{0} \\ {N}_{0} & {N}_{0} & {N}_{0} & {N}_{1} & & {P}_{0} & {P}_{0} & {P}_{0} & {P}_{1}\end{matrix} ) ,$$

With the above configuration of the convolution layers, J(C′)(x))=2C(x).

As shown, the scaling by a factor of two resulted from the fact that the weights in the updated layer C′ are duplicated from the weights in the layer C. This scaling of a constant would not affect the computation of any subsequent layers. In a non-limiting example, the layer 210 may be configured to set the scalar to divide the output by a factor of two. This may be implemented in hardware using a linear shift register configured to shift one bit to the right. When the scalar is set to ½ in the layer 210, the output of the layer 210 will be equal to the output of the C layer, so that J(C′(x))=C(x).

FIG. 3A illustrates a diagram of an example process of retrieving output of a given convolution layer in an AI chip in accordance with various examples described herein. In configuring an AI model in an AI chip, e.g., CeNN 200 (FIG. 2B) in an AI chip, a process 300 may include updating a given layer of an AI chip at 302. The given layer may be a convolution layer in a CeNN inside the AI chip, such as layer C (202). In updating the given layer, the process may modify the weights of the given layer, for example, as shown in FIG. 2B, modifying the weights in layer C (202) to form layer C′ (204). As shown, the updated layer C′ may have a different number of output channels than the original layer. In the example provided, if the number of input channels and the number of output channels of layer C (202) are n₀ and n₁, respectively, the output channels of layer C′ (204) is 2n₁.

With further reference to FIG. 3A, the process 300 may also include configuring a subsequent layer at 304. For example, the process may configure the subsequent layer at 304 as an identity layer J(210 in FIG. 2B) as shown above. The number of input channels of layer J is the same as the number of output channels of the modified given layer C′ (204 in FIG. 2B). The number of output channels of the layer J is the same as the number of output channels of the given layer, e.g., layer C (202 in FIG. 2A). In the above example, the number of output channels of layer J is n₁.

Additionally, the process 300 may set the scalar of the subsequent layer at 306. For example, the scalar may be implemented by configuring the hardware in the AI chip, such as a bit multiplier or a shifter in layer (210 in FIG. 2B) to shift one bit to the right, effectively dividing the result of layer J by half. This effectively generates an output at the subsequent layer equal to the output of the given layer.

Once the multiple convolution layers of the CeNN in the AI chip are configured (such as shown in FIG. 2B), the process 300 may include executing (running) the AI chip at 308. By executing the AI chip, the CeNN will also be executed to perform an AI task based on the weights and/or parameters in the CeNN. In the above described configuration (e.g., in FIG. 2B), the updated layers (e.g., layer C′, J in FIG. 2B) are loaded in the CeNN of the AI chip for execution. Under such configuration, the output of the subsequent layer (e.g., 210 in FIG. 2B) will be the same as the output of the selected given layer (e.g., 202 in FIG. 2A). Additionally, the process 300 may retrieve that output from the subsequent layer at 310. In some scenarios, the hardware of the AI chip may allow the output of a convolution layer in the CeNN to be retrieved by a tool, which may obtain the output of the convolution layer and transmit that output to a processing device, wired or wirelessly, for analysis. In such case, the output from the subsequent layer (e.g., 210 in FIG. 2B) may be obtained and transmitted to the processing device for analysis. In some scenarios, the hardware of an AI chip may not allow retrieving the output of an intermediate convolution layer in the CeNN. In such case, the one or more convolution layers between a selected given layer (e.g., 202 in FIG. 2A) and one or more fully co connected layers (e.g., 116 in FIG. 1B) may be updated in a similar manner, as described in detail in FIG. 2C.

With reference to FIG. 2C, the CeNN of an AI chip 200 may have the layer C (202 in FIG. 2A), one or more fully connected layers 226, and one or more layers (e.g., 218, 224) in between. Layer C may be modified as C′ 212, in a similar manner as described in FIG. 2B with respect to the modification of layer C (202) to layer C′ (204). In such case, similar to layer 204, layer 212 may also have two parts 214, 216, where the first part 214 may include weights copied from the weights of layer C, and the second part 216 mays include weights duplicated from the weights of layer C, to form additional number of output channels. The number of additional output channels may be the same as the number of output channels of layer C. This effectively doubles the number of output channels in layer C′.

The last layer 224 before the fully connected layer(s) 226 may be configured to have the weights of the identity layer J built in a similar manner as described in FIG. 2B with respect to the modification of layer J (210). One or more convolution layers between the layer C′ (212) and the layer J (e.g., 224) may be configured as layer in a similar manner as described for modifying layer C (202) to layer C′ (204) or similar to modifying layer C (202) to layer C′ (212), but based on the layer J. In other words, layer J′ may also include two parts 220, 222, where the first part 220 may include weights copied from the weights of layer J, and the second part 222 includes weights duplicated from the weights of layer J, to form an additional number of output channels. The number of additional output channels may be the same as the number of output channels of layer J. This effectively doubles the number of output channels in layer J′.

In a non-limiting example, layer C (202) may have n₀ input channels and n₁ output channels. The layer C′ may have n₀ input channels and 2n₁ output channels, the layer J may have 2n₁ input channels and n₁ output channels. The layer J′ (218) may be configured to have the weights of layer J and duplicate these weights to expand the number of output channels by twice, to form 2n₁ input channels and 2n₁ output channels. One or more additional layers J′ may be repeatedly configured in one or more additional layers between layer 212 and layer 224. Similar to the configurations described in FIG. 2B, the layer J (224), and or one or more layers J′ (218) may each additionally have a scalar configured to divide the result by a factor of two. The scalar may be configured and implemented in a similar manner as described in FIG. 2B. In above configuration, the output of the last convolution layer before the fully connected layer(s), such as layer 224 is the same as the output of the given C layer (2112>in FIG. 2A). As such, the output of the given layer 202 may be directly output through the output of the AI chip, effectively bypassing the intermediate layers between the given layer and the fully connected layer(s).

In some examples, a CeNN in an AI chip may be configured as shown in FIG. 2C to operate in a debugging mode. For example, layer C (202) (in the normal mode) may be updated into layer C′ (204), and a second layer (224) may be configured to be an identity layer J. The second layer (224) may be the last convolution layer before fully connected layer(s) in the CeNN. In the debugging mode, the CeNN may also have one or more intermediate layers between the updated layer C′ and the second layer (224) updated to have the weights of layer J′, where the weights of layer J′ are configured in a similar fashion as described in FIG. 2C. Altogether, the updated layer C′ and the second layer J, and the intermediate layer(s) between the updated layer C′ and the second layer J enable the CeNN to operate in the debugging mode. In the debugging mode, the output of layer C may be directly output from the AI chip.

FIG. 3B illustrates an example process of configuring the convolution layers in an AI chip in accordance with various examples described herein. For example, a process 320 may be implemented to configure the convolution layers described in FIG. 2B. The process 320 may include updating a given layer of an AI chip at 322. The given layer may be a convolution layer in a CeNN inside the AI chip, such as layer C (202). In updating the given layer, the process 320 may modify the weights of the given layer, for example, as shown in FIG. 2C, by modifying the weights in layer C (202) to form layer C″ (212). As shown, the modified layer C′ may have a different number of output channels than that of the original layer C. In the example provided, if the number of output channels of the layer C (202) is n₁, the output channels of the layer C′ (204) is 2n₁.

With further reference to FIG. 3B, the process 320 may also include configuring a second layer at 324. For example, the second layer may be a last layer before fully connected layer(s) in a CNN, e.g., 224 in FIG. 2C. In some examples, the process 320 may configure die last layer as an identity layer J (224 in FIG. 2C) in the manner as described above. The number of input channels of the layer J is the same as the number of output channels of the modified given layer C″ (212 in FIG. 2C). The number of output channels of the layer J is the same as the number of output channels of the given layer, e.g., layer C (202 in FIG. 2A). In the above example, the number of input channels of the layer J is 2n₁, and the number of output channels of the layer J is n₁.

Additionally, the process 320 may set the scalar of the second layer at 326. For example, the scalar may be implemented by configuring a hardware in the AI chip, such as a bit multiplier, or a shifter in the last layer (e.g., 224 in FIG. 2C) before fully connected layer(s) to shift one bit to the right, effective dividing the result of the last layer by half. The process 320 may further include configuring one or more intermediate layers between the given layer and the second layer at 328. In configuring the intermediate layers, the process 320 may configure the weights of each of these layers in a similar manner as described in FIG. 2C based on the layer J (224 in FIG. 2C). For example, each intermedia layer is configured as layer for which the weights are copied and duplicated from the weights in the layer J (224 in FIG. 2C) to double the number of output channels. In the above example, both the number of input channels and the number of output channels of the intermediate layers may be configured to be 2n₁. Using the process 320, the output of the second layer (e.g., 224 in FIG. 2C) equals the output of the given layer (the layer C 202 in FIG. 2A).

Once the multiple convolution layers of the CeNN in the AI chip are configured (such as shown in FIG. 2C), the process 320 may include executing (running) the AI chip at 330. By executing the AI chip, the CeNN will also be executed to perform an AI task based on the weights and/or parameters in the CNN. In the above described configuration (e.g., in FIG. 2C), the output of the second layer (e.g., 224 in FIG. 2C) will be the same as the output of the selected given layer (e.g., 202 in FIG. 2A). Additionally, the process 320 may retrieve that output from the second layer at 332 (e.g,., 224 in FIG. 2C). For example, a processor may be coupled to the AI chip to retrieve the output of the AI chip through the filly connected layer(s) at 226.

Although the configurations of the AI chip are shown to be implemented using the processes in FIGS. 3A and 3B, it is appreciated that variations of the processes may exist. In some examples, the order of the boxes in FIG. 3A or FIG. 3B may vary. For example, in the process 320 in FIG. 3B, the process may configure the intermediate layers J′ before configuring the second layer J. Alternatively, the process 300 or 320 may configure the scalar of a convolution layer before setting the weights in that layer. In a non-limiting example, the original layers in a CeNN of an AI chip may have . . . B4, C1, C2, C3, and C4, followed by fully connected layer(s) (FC1). To configure the AI chip to output the result of the layer C1, a process may include: updating layer C1 into C1′ a similar fashion as configuring layer 204 (FIG. 2B) or layer 212 (FIG. 2C); and inserting an identity layer J in a similar fashion as layer 210 (FIG. 2B) or layer 224 (FIG. 2C), so that the CeNN in the AI chip becomes B4->C1′->J->C2->C3->C4->FC1. The process may further remove the layer C2 so that the AI chip may have B4->C1′->J->C3->C4->FC1. The process may update the layer J as J′ in a similar fashion as modifying layer C1 into C1′ and insert a second layer, J, so that the configuration of the AI chip becomes B4->C1′->J′->J->C3->C4->FC1. The method may further remove layer C3, thus the AI chip has the structure of B4->C1′->J′->J->C4->FC1. The process may further repeat modifying the layer J into layer J′, inserting a layer J and removing layer C4, such that the structure of the CeNN becomes B4->C1′->J′->J′->J->FC1. This achieves the same configuration as shown in FIG. 2C.

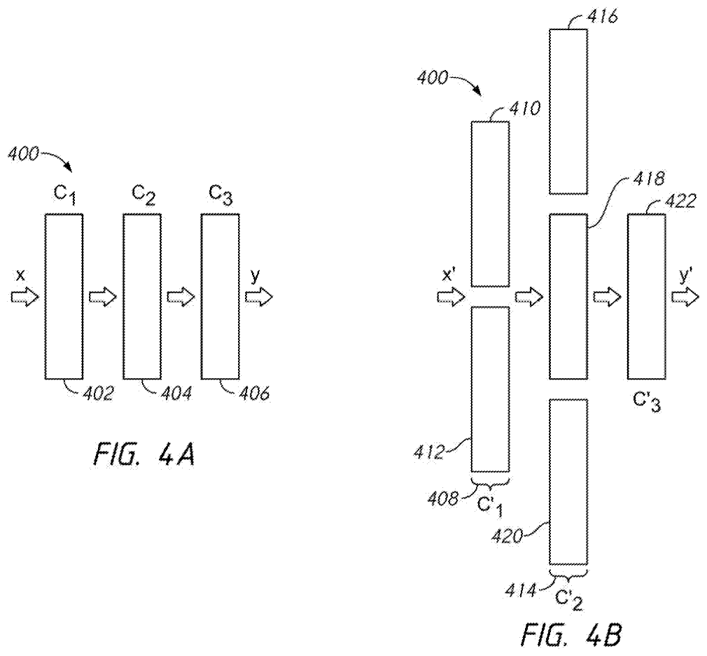

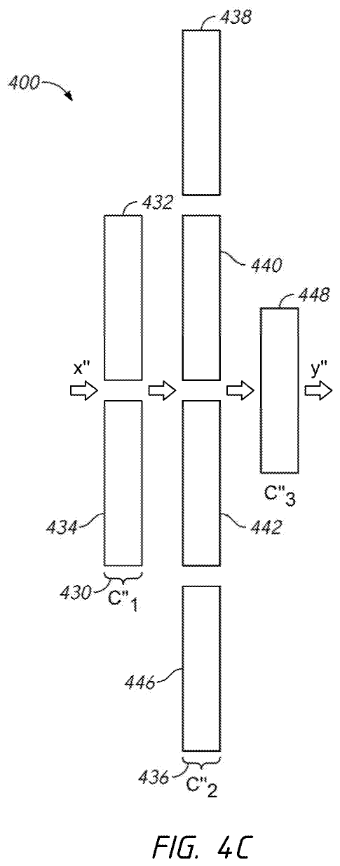

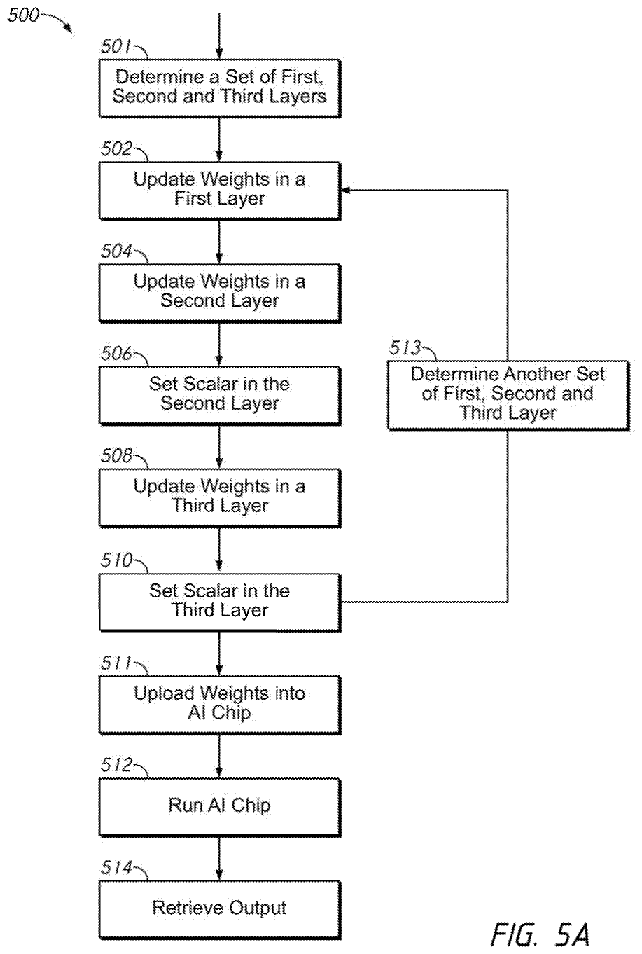

FIGS. 4A-4C illustrate various configurations of a CeNN in an AI chip in accordance with various examples described herein. In some examples, a CeNN, when configured to have a residual connection, may result in better performance. A residual connection may refer to two consecutive convolution layers with a skip connection. If the two consecutive layers are represented as Cₐ and C_{b}, respectively, then the residual connection produces C_{b}(Cₐ(x))-+x, instead of C_{b}(Cₐ(x)), where x is the input to the layer Cₐ. The residual connections transfer information more effectively through the many layers of a deep convolutional neural net, causing networks residual connections to be easier and faster to train, especially for a deep network, such as a network having 50-100 layers. For example, the performance of a ResNet architecture having residual connections may have an approximately 50% decrease in relative error on standard benchmarks.

In some examples, it is desirable to h ve one or more residual connections in a CeNN. With reference to FIG. 4A, an embedded CeNN in an AI chip may have three consecutive convolution layers, such as C₁ (402), C₂ (404), and C₃ (406). A desirable residual connection may be represented by C₃(C₂(C₁(x))))+C₁(x), where x is the input to layer C₁. FIG. 4B illustrates a configuration of a CeNN to generate such residual connection. As shown, the original layers C₁, C₂, and C₃ are updated in certain ways into layers C₁′, C₂′, and C₃′, respectively such that the output of C₃′, i.e., y′=C₃(C₂(C₁(x′)))+C₁(x′).

In some examples, the layers C₁, C₂, and C₃ of a CeNN may be updated as described below. The layer C₁ (402) may be updated into layer C₁′ (408) such that the weights of C₁′ may be copied and duplicated from the weights of C₁ by output channels such that:

$${C}_{1}^{′} = ( \begin{matrix}{C}_{1} \\ {C}_{1}\end{matrix} ) .$$

As shown, the C₁′ layer 408 may have two blocks, e.g., 410, 412, each corresponding to a number of output channels. For example, each of the two blocks 410, 412 may correspond to C₁ and stacked to each other. If the number of input and output channels of layer C₁ are n₀ and n₁, respectively, then the number of input and output channels of C₁′ will be n₀ and 2n₁, respectively. The layer C₁′ is configured in a similar manner as described in C′ (204 in FIG. 2B, 212 in FIG. 2C).

In some examples, layer C₂ (404) may be updated into C₂′ (414) such that:

$${C}_{2}^{′} = \frac{1}{2} ( \begin{matrix}{C}_{1} & & {C}_{2} \\ & J & \\ & J & \end{matrix} ) .$$

As shown, the layer C₂′ (414) may have three blocks, e.g., 416, 418, 420, each corresponding to a number of output channels. Block 416 may correspond to (C₂, C₂), and each of blocks 418 and 420 may correspond to an identity matrix J. The weights of block 416 may be copied from the weights of layer C₂ and duplicated by the input channels. The weights of layer C₂′ may be further filled in with two identity matrices J corresponding to blocks 418 and 420. For example, the number of input channels and the number of output channels of C₂ may be n₁ and n₂, respectively. Thus, the number of input channels of C₂′ may be 2n₁ after duplication from the weights of C₂. Each of the matrices J is configured in a similar manner as the weights in layer J (e.g., 210 in FIG. 2B, 224 in FIG. 2C) are configured. In the above example, each matrix J may have the dimension of 2n₁×n₁, which results in the number of output channels of C₂′ being n₂+2n₁. In implementation, the scalar (e.g., a bit multiplier or a shifter) in layer C₂′ may be configured to be a multiplier of ½, such as by using a right linear shift register in the AI chip.

In some examples, the layer C₃ (406) may be updated into C₃′ (422) such that:

$${C}_{3}^{′} = ( \begin{matrix}{C}_{3} & \frac{1}{2} J\end{matrix} ) .$$

As shown, the weights of layer C₃′ in some input channels may be copied from the weights in layer C₃, and filled in by an identity matrix J in the remaining input channels. The matrix J may be built in a similar manner as the weights in layer (e.g., 210 in FIG. 2B, 224 in FIG. 2C) are configured. In the above example, matrix J may have the dimension of 2n₁×n₁. If the numbers of input and output channels of C₃ are n₂ and n₁, respectively, then the numbers of input and output channels of C₃′ are n₂+2n₁ and n₁, respectively. In implementation, a bit multiplier for a portion (e.g., a block) of the C₃′ layer may be configured to be at multiplier of ½ such that ½ J may be implemented. As shown, the above configuration may require a block-wise bit multiplier (such as in layer C₃′) to produce a residual connection. Under the above configuration, a residual connection may be achieved at the output of the C₃′ layer, such that y′=C₃(C₂(C₂(x′)))=C₃(C₂(C₁(x)))+C₁(x),

FIG. 4C illustrates a variation of the configuration of the AI chip in FIG. 4B, where layers C₁ (402), C₂ ((404), and C₃ (406) may be updated into C₁″ (430), C₂″ (436) and C₃″ (448), respectively. In some examples, the layer C₁ (402) may be modified into layer C₁″ (430) such that the weights of C₁″ may be copied and duplicated from the weights of C₁ by output channels such that:

$${C}_{1}^{″} = ( \begin{matrix}{C}_{1} \\ {C}_{1}\end{matrix} )$$

As shown, the C₁ layer 430 may have two blocks, e.g., 432, 434, each corresponding to a number of output channels. Each of the blocks 432, 434 may be a half portion being identical to each other. For example, each of the two blocks 432, 434 may correspond to C₁ and stacked to each other. If the number of input and output channels of layer C₁ are n₀ and n₁, respectively, then the number of input and output channels of C₁″ will be n₀ and 2n₁, respectively. The layer C₁″ is configured in a similar manner as described in C′ (204 in FIG. 2B, 212 in FIG. 2C) and C′ (408 in FIG. 4B).

In some examples, layer C₂ (404) may be updated into C₂″ (436) such that:

$${C}_{2}^{″} = \frac{1}{2} ( \begin{matrix}{C}_{2} & & {C}_{2} \\ {C}_{2} & & {C}_{2} \\ & J & \\ & J & \end{matrix} )$$

As shown, the layer C₂″ (436) may have four blocks, e.g., 438, 440, 442, and 446, each corresponding to a number of output channels. Each of the blocks 438 and 440 may be identical. For example, each of the blocks 438 and 440 may correspond to (C2, C2). As shown, each of the blocks 438 and 440 may also contain a first half and a second half identical to the first half, such as C2, C2. For example, the weights of block 438, 440 may be copied from the weights of layer C2 and duplicated by the input channels. The weights of layer C₂″ may be further filled in with two identity matrices J corresponding to blocks 442 and 446. Each of the blocks 442 and 446 may be identical to each other and also contain weights of an identity matrix J. In the above example, the number of input channels and the number of output channels of C2 may be, n₁ and n₂, respectively. Thus, the number of input channels of C₂″ may be 2n₁ after duplication from the weights of C2. Each of the matrices J are configured in a similar manner as the weights in layer J (e.g., 210 in FIG. 2B, 224 in FIG. 2C) are configured. In the above example, each matrix J may have the dimension of 2n₁×n₁, which results in the number of output channels of C₂″ being 2n₂+2n₁. In implementation, the scalar (e.g., a bit multiplier or a shifter) in layer C₂″ may be configured to be a multiplier of ½, such as by using a right linear shift register in the AI chip.

In some examples, the layer C₃ (406) may be updated into C₃″ (448) such that:

C″₃=1/2(C₃ C₃ J)

The weights of layer C₃″ in some input channels may be copied and duplicated from the weights in layer C₃, and filled in by an identity matrix J in the remaining input channels. As shown, the weights of layer C₃″ may include first and second portions (e.g., C₃, C₃) being identical to each other, and a third portion containing weights of an identity matrix J. The matrix J may be built in a similar manner as the weights in layer J (e.g., 210 in FIG. 2B, 224 in FIG. 2C) are configured. In the above example, matrix J may have the dimension of 2n₁×n₁. If the numbers of input and output channels of C₃ are n₂ and n₁, respectively, then the numbers of input and output channels of C₃″ are 2n₂+2n₁ and n₁, respectively. Under the above configuration, a residual connection may be achieved at the output of the layer C₃″, e.g., y″=C₃(C₂(C₁(x″)))=C₃(C₂(C₁(x)))+C₁(x).

In comparing the layer C₂″ with layer C₂′ (414 in FIG. 4B), and layer C₃″ to layer C₃′ (422 in FIG. 4B), the configuration in FIG. 4C may require more memory space than that in FIG. 4B because the layer C₂″ has a larger number of output channels than that in layer C₂′. Similarly, the number of input channels in the layer C₃″ is also greater than that of the layer C₂′. As shown, in the configuration in FIG. 4C, each of layers C₂″, C₃″ may require a layer-wise scalar. In comparison, in configuration in FIG. 4B, the residual connection may require a block-wise scalar, such as a scalar in layer C₃′.

In implementation, a bit multiplier (e.g., the scalar) in layer C₂″ may be configured to be a multiplier of ½, such as by using a right linear shift register in the AI chip. As shown, the above configuration may require a layer-wise bit multiplier (such as in layer C₂″ and C₃′) to produce a residual connection.

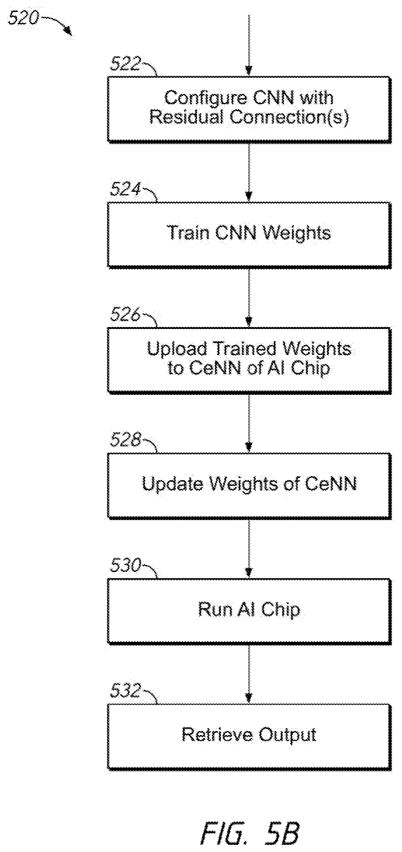

FIG. 5A illustrates a diagram of an example process of configuring a CeNN to generate a residual connection in accordance with various examples described herein. In configuring the convolution layers of an AI model, convolution layers 400 (FIGS. 4A-4C) in an AI chip, a process 500 may include determining a set of first, second, and third layers at 501, to configure the residual connection. The process 500 may include updating weights in a first layer at 502. The first layer may be a convolution layer in a CeNN inside the AI chip, such as layer C₁ (402 in FIG. 4A). In updating the first layer, the process may include modifying the weights of the first layer, for example, as shown, in FIG. 4B (modifying the weights in layer C₁ (402 in FIG. 4A) to form layer C₁′ (404)) or as shown in FIG. 4C (modifying the weights in layer C₁ (402 in FIG. 4A) to form layer C₁″ (430)). As shown, the modified layer C₁′ may have a different number of output channels than the original layer. In the example provided, if the number of input channels and the number of output channels of the C₁ layer (202) are n₀ and n₁, respectively, the output channels of the C′ layer (204) is 2n₁.

With further reference to FIG. 5A, the process 500 may also include updating weights in a second layer C₂ 584. In some examples, the second layer may be a layer subsequent to layer C₁. In updating the weights in C₂, the layer C₂ may become layer C₂′ as described in FIG. 4B. For example, the process may configure the second layer by duplicating the weights of the second layer by the number of input channels, and expanding the output channels by two identity matrices. Matrix J may be configured in a similar manner as the weights of the layer J (e.g., 210 in FIG. 2B) are configured, as shown above. In the above example, the matrix J may have a dimension of 2n₁ (corresponding to the number of input channels) by n₁ (corresponding to the number of output channels). As such, if the number of output channels of layer C₂ is n₂, the numbers of input and output channels of the modified layer C₂′ may have the values of 2n₁ and n₂+2n₁, respectively. Additionally, and/or alternatively, the process 500 may set the scalar of the second layer at 506. For example, the process 500 may set the scalar of the second layer to a value of ½. In some examples, setting the scalar may correspondingly set a linear shift register in the second layer of the AI chip to right shill by one bit.

Alternatively, in updating the weights in the second layer at 504, in some examples, the layer C₂ may become layer C₂″ (436 in FIG. 4C). For example, the process may configure the second layer by duplicating the weights of the second layer to expand the number of input channels, and further expand the output channels by the duplicated weights. The process may further expand the output channels by two identity matrices. An identity matrix J may be configured in a similar manner as the weights of the layer J (e.g 210 in FIG. 2B, 224 in FIG. 2C) are configured, as shown above. In the above example, the number of input channels of the layer J is the same as the number of output channels of the updated layer C₁″ (430 in FIG. 4C). In the above example, the matrix J may have a dimension of 2n₁ (corresponding to the number of input channels) by n₁ (corresponding to the number of output channels). As such, if the number of output channels of layer C₂ is n₂, the numbers of input and output channels of the updated C₂″ layer may have the values of 2n₁ and 2n₂+2n₁, respectively. Additionally, and/or alternatively, the process 500 may set the scalar of the second layer at 506. For example, the process 500 may set the scalar of the second layer to a value of ½. In some examples, setting the scalar may correspondingly set a linear shift register in the second layer of the AI chip to right shift by one bit.

With further reference to FIG. 5A, the process 500 may include updating weights in a third layer C₃ at 508. In some examples, the third layer may be a layer subsequent to the second layer (e.g., 406 in FIG. 4A). In updating the weights in C₃, the layer C₃ may become layer described in FIG. 4B. For example, the process may configure the third layer by copying the weights of the third layer, and expanding the input channels by an identity matrix. The identity, matrix J may be configured in a similar manner as the weights of the layer J (e.g., 210 in FIG. 2B) are configured, as shown above. In the above example, the number of input channels of the layer J is the same as the number of output channels of the updated layer C₂″ (414 in FIG. 4B). In the above example, the matrix J may have a dimension of 2n₁ (corresponding to the number of input channels) by n₁ (corresponding to the number of output channels). As such, if the number of input channels and the number of output channels of layer C₃ are n₂and n₁, respectively, the numbers of input and output channels of the modified C₃″ layer may have the values of n₂+2n₁ and n₁, respectively. Additionally, and/or alternatively, the process 500 may set the scalar of the third layer at 510. For example, the process may set the bit multiplier of a portion (e.g., a block) of the third layer. For example, the process 500 may set the scalar of the matrix J in the third layer (e.g., 422 in FIG. 4B) to a value of ½.

Alternatively, in updating the weights in the third layer, in some examples, the layer C₃ may become layer C₃″ as described in 448 in FIG. 4C. For example, the process may configure the third layer by copying and duplicating the weights of the third layer by the number of input channels, and further expanding the input channels by an identity matrix. The identity matrix J may be configured in a similar manner as the weights of the layer J (e.g., 210 in FIG. 2B) are configured, as shown above. In the above example, the number of input channels of the layer J is the same as the number of output channels of the updated layer C₂″ (436 in FIG. 4C). In the above example, the matrix J may have a dimension of 2n₁ (corresponding to the number of input channels) by n₁ (corresponding to the number of output channels). As such, if the number of input channels and the number of output channels of layer C₃ are n₂ and n₁, respectively, the numbers of input and output channels of the modified layer C₃″ may have the values of 2n₂+2n₁ and n₁, respectively. Additionally, and/or alternatively, the process 500 may set the scalar of the third layer at 510. For example, the process may set the bit multiplier of the third layer. For example, the process 500 may set the scalar of the third layer to a value of ½. In some examples, setting the scalar may correspondingly set a linear shift register in the third layer of the AI chip to right shift by one bit.

Once the multiple convolution layers of the CeNN in the AI chip are configured (such as shown in FIG. 4B or FIG. 4C), the process 500 may include uploading the updated weights into the AI chip at 511, and executing (running) the AI chip at 512. By executing the AI chip, the CeNN will also be executed to perform an AI task based on the weights and/or parameters in the CeNN. In the above described configuration (e.g., in FIGS. 4B or 4C), the output of the third layer (e.g., 422 in FIG. 4B, 448 in FIG. 4C) will be the residual connection, e.g., C₃(C₂(C₁(x))))+C₁(x). Additionally, the process 500 may retrieve the output from the AI chip at 514.

In some examples, a CeNN may include one or more additional residual connections. For example, the process may include determining another set of first, second, and third layer at 513 for building an additional residual connection. In building the additional residual connection, the process 500 may repeat the same blocks 502, 504, and 508 for the first, second, and third layers in the additional set, respectively. Additionally, the process 500 may also include setting the scaler in the second layer at 504. The process 500 may also set the scalar in the third layer at 510. The process may repeat blocks 502-510 in a similar fashion to configure additional residual connections (layers) in the CeNN.

In some scenarios, a CNN may be configured to have the same residual connection(s) as the CeNN of the AI chip and trained to obtain one or more weights. As shown in FIG. 5B, a process 520 may configure a CNN with residual connection(s) at 522. For example, the process 510 may configured the CNN to have the same number of residual connection(s) at the same location(s) as in a CeNN of an AI chip. The process 520 may train the CNN weights at 524. Any suitable neural network training methods can be used. For example, the process 524 may retrieve a test set containing training images, perform an image recognition task for each of the training images using the configured CNN, retrieve the image recognition results from the CNN, compare the image recognition results with the ground truth data for the training images, and obtain the trained weights of the CNN.

With further reference to FIG. 5B, the process 520 may upload the trained weights to the CeNN of the AI chip at 526. Now, the trained weights are based on the CNN having residual connection configurations. In performing a real-time AI task, the CeNN in the AI chip needs to have the same residual connection(s) as those in the CNN in the training. In configuring the residual connection(s), the process 520 may further update one or more layers of the CeNN at 528. For example, box 528 may implement the process described in FIG. 5A, such as boxes 502-510, and configure one or more residual layers in the same configuration as in the CNN in the training. Once one or more layers in the CeNN are updated, the process 520 may further include executing the AI chip at 530 and retrieving the output at 532. In executing the AI chip, the process 520 may implement an AI task, such as an audio recognition (e.g., voice recognition) or image recognition (e.g., face recognition) task.

With reference to FIGS. 3A, 3B, 5A, and 5B, in some examples, in updating various layers in the AI chip (e.g., C in FIG. 2A or C₁, C₂, C₃ in FIG. 4A), the corresponding processes (e.g., 300 in FIG. 3A, 320 in FIG. 3B, 500 in FIG. 5A, 520 in FIG. 5B) may update the weights of certain layers without affecting the weights of the other layers in the AI chip. For example, one of the processes (e.g., 300 in FIG. 3A, 320 in FIG. 3B, 500 in FIG. 5, 520 in FIG. 5B) may erase one or more layers to be updated, and fill in the deleted layers with the weights and/or parameters as modified such as weights C′, J′, C₁′, C₂′, C₃′, C₁″, C₂″, C₃″. In some examples, one of the processes (e.g., 300 in FIG. 3A, 320 in FIG. 3B, 500 in FIG. 5, 520 in FIG. 5B) may keep a copy of the original weights in the AI chip, modify a subset of the original weights which correspond to the weights of certain layers of the AI chip to be updated in a processing device. The weights of these certain layers of the AI chip may be updated in accordance with the descriptions in FIGS. 2-5, for outputting a given convolution layer or generating residual connection in the AI chip. Once all of the weights of the AI chip are updated, the process (e.g., 300 in FIG. 3A, 320 in FIG. 3B, 500 in FIG. 5, 520 in FIG. 5B) may load the weights of all of the layers to the CeNN in the AI chip at once. Alternatively, only updated weights may be loaded to the CeNN, depending on the hardware.

The various embodiments in FIGS. 2-5 may facilitate various, applications, especially using a low-precision AI chip in performing certain AI tasks. For example, a low-cost low-precision AI chip with the weights having 1-bit values may be used in a surveillance video camera. Such camera may be capable of performing real-time face recognition to automatically distinguish unfamiliar intruders from registered visitors. The use of such AI chip may save the network bandwidth, power costs, and hardware costs associating with performing an AI task involving a deep learning neural network. With the embodiments in FIGS. 2-3, it may be feasible to retrieve the output of a given convolution layer in such 1-bit CeNN, for either debugging or real-time applications. For example, in debugging of a CNN, a debugging process may select a middle layer of the multiple convolution layers in the CNN and retrieve the output of the selected middle layer from the AI chip using the process in FIGS. 3A or 3B. By evaluating the output of the middle layer, the debugging process may determine whether a bug occurred in the first half or the second half of the network. The debugging process may further select a second layer in the faulty half of the network and repeat the same search process until the bug is found.

In some examples, a fault/bug may result from low-level issues. For example, the hardware in the AI chip may be corrupted or is erroneously deleting data at intermediate layers in the net. A debugging process may implement the process described in FIGS. 3A-3B to identify the low-level issues. For example, the, process may set certain layers to identify the defective layer. Similarly, if the hardware is malfunctioning due to overheating and is exhibiting non-reproducible behavior, a debugging process using the embodiments in FIGS. 3A-3B may identify, at a layer level, how often the malfunctions occur at a given layer or a range of layers in the AI chip.

In some examples, a fault may result from other low-level issues. For example, a driver may be available to convert the output data from a physical layer of the AI chip to a data format usable by a processing device that receives the output data from the AI chip. The processing device may generate a diagnosis report or display debugging result on a display based on the output data. In some instances, a driver may generate compressed data suitable for a peripheral of the processing device to receive the data. In some scenarios, a driver may be faulty. In the embodiments described in FIGS. 2-3, inserting a layer J after the selected layer of interest may help identify whether the fault results from a driver code or elsewhere.

In some examples, in training an AI model to be loaded into an AI chip for performing real-time AI tasks, an A I model may be initialized from a pre-trained checkpoint, such as an AI model that has already been trained with previous training data. For example, in image recognition tasks, an AI model may have been trained with previous training images to recognize certain high-level features, such as eyes and hair. As some of the pre-trained checkpoints make use of network architectures supporting residual connections, the embodiments in FIGS. 4-5 enable generic 1-bit convolutional accelerators to simulate residual connections, to be able to speed up the training, and fine-tuning process in obtaining an AI model in a CeNN.

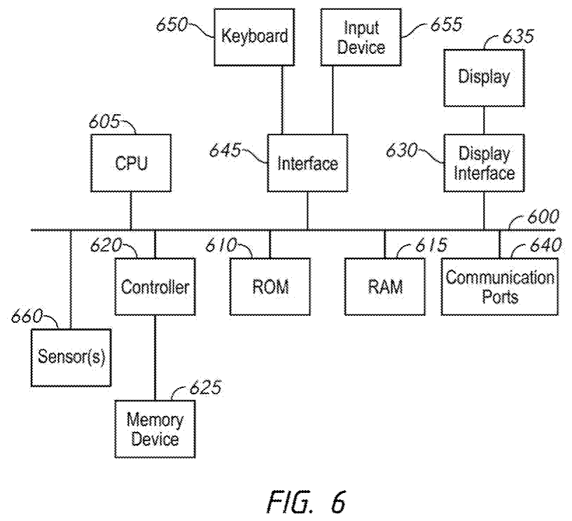

FIG. 6 illustrates various embodiments of one or more electronic devices for implementing the various methods and processes described in FIGS. 1-5. An electrical bus 600 serves as an information highway interconnecting the other illustrated components of the hardware. Processor 605 is a central processing device of the system, configured to perform calculations and logic operations required to execute programming instructions. As used in this document and in the claims, the terms “processor” and “processing, device” may refer to a single processor or any number of processors in a set of processors that collectively perform a process, whether a central processing unit (CPU) or a graphics processing unit (GPU), or a combination of the two. Read only memory (ROM), random access memory (RAM), flash memory, hard drives, and other devices capable of storing electronic data constitute examples of memory devices 625. A memory device, also referred to as a computer-readable medium, may include a single device or a collection of devices across which data and/or instructions are stored.

An optional display interface 630 may permit information from the bus 600 to be displayed on a display device 635 in visual, graphic, or alphanumeric format. An audio interface and audio output (such as a speaker) also may be provided. Communication with external devices may occur using various communication ports 640 such as a transmitter and/or receiver, antenna, an RFID tag and/or short-range, or near-field communication circuitry. A communication port 640 may be attached to a communications network, such as the Internet, a local area network, or a cellular telephone data network.

The hardware may also include a user interface sensor 645 that allows for receipt of data from input devices 650 such as a keyboard, a mouse, a joystick, a touchscreen, a remote control, a pointing device, a video input device, and/or an audio input device, such as a microphone. Digital image frames may also be received from an image capturing device 655 such as a video or camera that can either be built-in or external to the system. Other environmental sensors 660, such as a GPS system and/or a temperature sensor, may be installed on system and communicatively accessible by the processor 605, either directly or via the communication ports 640. The communication ports 640 may also communicate with the AI chip to upload or retrieve data to/from the chip. For example, a processing device on the network implementing the process 300 in FIG. 3A may retrieve weights from, upload weights to, or otherwise execute the AI chip for performing an AI task via the communication port 640. Optionally, the processing device may use an SDK (software development kit) to communicate with the AI chip via the communication port 640. The processing device may also retrieve the output of a given layer in an AI chip (e.g., 310 in FIG. 3A, 332 in FIG. 3B) or the result of an AI task at the output of the AI chip (e.g., 514 in FIG. 5A, 532 in FIG. 5B) via the communication port 640. The communication port 640 may also communicate with any other interface circuit or device that is designed for communicating with an integrated circuit.

Optionally, the hardware may not need to include a memory, but instead programming instructions are run on one or more virtual machines or one or more containers on a cloud. For example, the various methods illustrated above may be implemented by a server on a cloud that includes multiple virtual machines, each virtual machine having an operating, system a virtual disk, virtual network and applications, and the programming instructions for implementing various functions in the robotic system may be stored on one or more of those virtual machines on the cloud.

Various embodiments described above may be implemented and adapted to various applications. For example, the AI chip having a CeNN architecture may be residing in an electronic mobile device. The electronic mobile device may use the built-in AI chip to produce results from intermediate layers in the CeNN of the AI chip. In other scenarios, the processing device may be a server device in the communication network (e.g., 102 in FIG. 1) or may be on the cloud. The processing device may implement a CeNN architecture with residual connections in the network. In some scenarios, the debugging or evaluating of the intermediate results, or training of the AI model using pre-trained checkpoints, may also be implemented in such processing device. These are only examples of applications in which various systems and processes may be implemented.

The various systems and methods disclosed in this patent document provide advantages over the prior art, whether implemented, standalone, or combined. For example, by using an identity layer in an AI chip, the output of a given layer in the network can be retrieved. Whereas using the identity layer includes modifying the weights of one or more layers after the given layer, such operation may require updating only one or more layers in the network without needing to update the rest of the network. This results in significant saving in the memory or hardware resource, particularly when the AI model becomes large or involves a deep neural network. Additionally, by implementing residual connections in a CeNN architecture, the training of certain AI models may be expedited using the one-bit CeNN in the AI chip.

It will be readily understood that the components of the present solution as generally described herein and illustrated in the appended figures could be arranged and designed in a wide variety of different configurations. Thus, the detailed description of various implementations, as represented herein and in the figures, is not intended to limit the scope of the present disclosure, but is merely representative of various implementations. While the various aspects of the present solution are presented in drawings, the drawings are not necessarily drawn to scale unless, specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages, and characteristics of the present solution may be combined in any suitable manner in one or more embodiments. One ordinarily skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Other advantages can be apparent to those skilled in the art from the foregoing specification. Accordingly, it will be recognized by those skilled in the art that changes, modifications, or combinations may be made to the above-described embodiments without departing from the broad inventive concepts of the invention. It should therefore be understood that the present solution is not limited to the particular embodiments described herein, but is intended to include all changes, modifications, and all combinations of various embodiments that are within the scope and spirit of the invention as defined in the claims.

1. A system comprising:
a processor; and
a non-transitory computer readable medium containing programming instructions that, when executed, will cause the processor to:
update a first convolution layer of a cellular neural network (CeNN) in an AI integrated circuit into an updated first convolution layer by duplicating weights of the first convolution layer, wherein a number of output channels of the updated first convolution layer is twice as a number of output channels of the first convolution layer;
configure a second convolution layer of the CeNN, wherein weights of the second convolution layer include weights of an identity layer, and the second convolution layer includes:
a number of input channels equal to the number of output channels of the updated first convolution layer, and
a number of output channels equal to the number of output channels of the first convolution layer; and
load at least the weights of the updated first convolution layer and the second convolution layer into the AI integrated circuit.

2. The system of claim 1, wherein the programming instructions further comprising programming instructions configured to:
cause the AI integrated circuit to execute based at least on the loaded weights of the updated first convolution layer and the weights of the second convolution layer; and
retrieve output of the second convolution layer from the AI integrated circuit.

3. The system of claim 1, wherein the programming instructions further comprising programming instructions configured to set a scalar in the second convolution layer to be configured to shift to right by one bit.

4. The system of claim 1, wherein the weights of the updated first convolution layer comprise;
a first portion including the weights of the first convolution layer; and
a second portion including the weights in the first portion;
wherein each of the first portion and the second portion corresponds to a number of output channels equal to the number of output channels of the first convolution layer.

5. The system of claim 1, wherein the weights of the updated first convolution layer and weights of the identity layer include binary values.

6. The system of claim 1, wherein the second convolution layer is subsequent to the first convolution layer in the CeNN.

7. The system of claim 1, wherein the second convolution layer is a last convolution layer immediately before one or more fully connected layers, and wherein programming instructions further comprise additional programming instructions configured to configure one or more intermediate convolution layers between the first convolution layer and the second convolution layer, wherein:
weights of each of the one or more intermediate convolution layers are duplicated from weights of the second convolution layer, and
each of the one or more intermediate convolution layers has a number of input channels equal to the number of output channels of the updated first convolution layer, and a number of output channels equal to the number of output channels of the updated first convolution layer.

8. A method comprising, at a processing device:
updating a first convolution layer of a convolution neural network (CNN) into an updated first convolution layer by duplicating weights of the first convolution layer, wherein a number of output channels of the updated first convolution layer is twice as a number of output channels of the first convolution layer;
configuring a second convolution layer of the CNN, wherein weights of the second convolution layer include weights of an identity layer, and the second convolution layer includes:
a number of input channels equal to the number of output channels of the updated first convolution layer, and
a number of output channels equal to the number of output channels of the first convolution layer; and
loading at least the weights of the updated first convolution; layer and weights of the second convolution layer into an embedded cellular neural network (CeNN) of an AI integrated circuit.

9. The method of claim 8 further comprising:
causing the AI integrated circuit to execute based at least on the loaded weights of the updated first convolution layer and the weights of the second convolution layer; and
retrieving output of the second convolution layer from the AI integrated circuit.

10. The method of claim 8 further comprising setting a scalar in the second convolution layer in the CeNN of the AI integrated circuit to be configured to shift to right by one bit.

11. The method of claim 8, wherein the weights of the updated first convolution layer comprise:
a first portion including the weights of the first convolution layer; and
a second portion including the weights in the first portion;
wherein each of the first portion and the second portion corresponds to a number of output channels equal to the number of output channels of the first convolution layer.

12. The method of claim 8, wherein the weights of the updated first convolution layer and weights of the identity layer include binary values.

13. The method of claim 8, wherein the second convolution layer is subsequent to the first convolution layer in the CNN.

14. The method of claim 8, wherein the second convolution layer is a last convolution layer immediately before one or more fully connected layers.

15. The method of claim 14 further comprising configure one or more intermediate convolution layers between the first convolution layer and the second convolution layer, wherein:
weights of each of the one or more intermediate convolution layers are duplicated from weights of the second convolution layer, and
each of the one or more intermediate convolution layers has a number of input channels equal to the number of output channels of the updated first convolution layer, and a number of output channel s equal to the number of output channels of the updated first convolution layer.

16. An artificial intelligence (AI) integrated circuit comprising: an embedded cellular neural network (CeNN) comprising a first convolution layer and a second convolution layer, the CeNN is configurable to:
operate in a first mode to perform an AI task; and
operate in a second mode to produce an output of the first convolution layer;
wherein, in the second mode:
the first convolution layer comprises weights duplicated from weights of the first convolution layer in the first mode, a number of output channels twice as a number of output channels of the first convolution layer in the first mode, and
the second convolution layer comprises weights of an identity layer, a number of input channels equal to the number of output channels of the first convolution layer in the second mode, and a number of output channels equal to the number of output channels of the first convolution layer in the first mode.

17. The AI integrated circuit of claim 16, wherein the output of the first convolution layer in the second mode is accessible to an external processing device.

18. The AI integrated circuit of claim 16, wherein a scalar in the second convolution layer is configured to shift to right by one bit in the second mode.

19. The AI integrated circuit of claim 16, wherein the weights of the first convolution layer in the second mode comprise:
a first portion including the weights of the first convolution layer in the first mode; and
a second portion also including the weights of the first convolution layer in the first mode.

20. The AI integrated circuit of claim 16, wherein the weights of the first convolution layer and weights of the second layer include binary values in the first mode and the second mode.

21. The AI integrated circuit of claim 16, wherein the second convolution layer is subsequent to the first convolution layer in the CeNN.

22. The AI integrated circuit of claim 16, wherein the second convolution layer is a last convolution layer in the CeNN, and one or more intermediate convolution layers between the first convolution layer and the second convolution layer are further configurable in the second mode, wherein;
weights of each of the one or more intermediate convolution layers are duplicated from weights of the second convolution layer in the second mode, and
each of the one or more intermediate convolution layers has a number of input channels equal to the number of output channels of the first convolution layer in the second mode, and a number of output channels equal to the number of output channels of the first convolution layer in the second mode.
